(19) United States
(12) Patent Application Publication
(10) Pub. No.: US 2007/0258382 A1
(43) Pub. Date: Nov. 8, 2007

(54) System and method for monitoring a data network segment

(75) Inventors: Dominique Le Foll, Ivybridge (GB); Jean Schmitt, Rouvres (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: ACTERNA FRANCE SAS, Saint-Etienne (FR)

(21) Appl. No.: 11/445,545

(22) Filed: Jun. 2, 2006

(30) Foreign Application Priority Data
May 2, 2006 (EP) 06300424.6

(51) Int. Cl. H04J 1/16

(52) U.S. Cl. 370/252

(57) ABSTRACT

The invention relates to a monitoring system and method for performing a connectivity check and a trace routing test in Ethernet based networks built around VLAN switching. For the connectivity check, a beacon frame is inserted at an originating point by an initiating test unit for transmission to a destination point provided with a loop for returning a response frame to the initiating test unit whenever the beacon frame is received, thereby confirming connectivity between the originating and destination points. For the trace routing test, a marker frame is inserted at the originating point by the initiating test unit and monitored as it passes through network nodes along its way towards the destination point. At any node where the beacon frame is detected, a tracing frame containing a copy of the marker frame is returned to the initiating test unit to build a sequential list of every node where the marker frame is detected.

### CROSS-REFERENCE TO RELATED APPLICATIONS

The present invention claims priority from European Patent Application No. 06300424.6 filed May 2, 2006, which is incorporated herein by reference for all purposes.

### TECHNICAL FIELD

The present invention relates generally to monitoring of data communication networks, and particularly to performing connectivity checks and route tracing in Ethernet based networks built around VLAN switching.

### BACKGROUND TO THE INVENTION

Data communication networks are comprised, in general, of a patchwork of diverse network segments (e.g., metro access networks and core networks using a variety of technologies) that may belong to different organizations. Typically the core nodes are fully meshed, whereas the metro nodes, outnumbering the core nodes by one order of magnitude, are highly redundant with at least 2-3 links between each metro node and the core, thereby affording some network redundancy. Each network segment generally includes a variety of nodes (such as bridges, LAN switches, routers, cross-connections and telephone switches) interconnected by a variety of links (such as cables, point-to-point radio connections and optical fibers). Some of the nodes include ports, for attaching external devices (referred to as end-points or hosts) such as computers, terminals, handsets, and multiplexers. A major concern is to supervise connectivity between two end points in such networks, especially when it comes to identifying a faulty node or link upon connectivity failure between the two end points.

U.S. Pat. No. 5,477,531 discloses dedicated point-to-point testing equipment, which typically requires two users to coordinate their operations in order to identify a misbehaving component of the network. This solution becomes time consuming and expensive for testing relatively large network, where the testing equipment must be moved between many ports of the network. Furthermore, this type of end-to-end test by itself provides no further information as to the source and location of the problem within the network.

There are other solutions intended for IP-based networks, such as the Distributed Ethernet IP Test-head QT-600 provided by JDSU (see www.idsu.com), which depend for their operation on the information provided within an IP-based network layer representing layer 3 in Open System Interconnection (OSI) model, and is therefore not applicable to data networks operating at the lower OSI layers, such as Ethernet Virtual Local area Networks (VLAN), which operate up to layer 2.5 of the OSI model. For an overview of Ethernet and the OSI model, see “Fundamentals of Ethernet” by Todd Rapposelli (Acterna, August 2005), available at www.idsu.com.

IEEE standards 802.1ah and 802.1ag for Ethernet, which are incorporated herein by reference, define Operation and Maintenance (OAM) procedures for Ethernet networks. Similarly ITU standard 1.610 defines OAM procedures for ATM networks. These standards, however, rely on compliance of various network elements to the respective standard, and would not therefore be generally applicable when the data network is comprised of more than one different type of network segments, some of which may not be fully compliant to either one of these standards.

The proposed solution offers a method to provide continuity monitoring and the route tracing to such network. In view of the limitations in the prior art reviewed above, there remains a clear need for an economical monitoring system to provide connectivity checking and trace routing for communication network operating below the OSI network layer, without requiring compliance of various component networks to a particular standard.

It is an object of the present invention to provide improved system and method for performing end-to-end connectivity tests and route tracing within a VLAN, independently of any network layer protocol.

### SUMMARY OF THE INVENTION

Accordingly, the present invention relates to operation and maintenance of Ethernet based Networks with connectivity checking and trace routing capability. The invention is particularly applicable to Ethernet based networks; more specifically on Ethernet networks built on VLAN switching. Te invention permits checking the continuity of Ethernet route end-to-end and by network segment, independently of the network equipment capabilities, by using special frames that are not necessarily defined by specific standards.

In a first aspect, the present invention there provides a monitoring system for a data network serving a plurality of end and intermediate points interconnected by a plurality of nodes, the system comprising a first test unit and at least one traffic monitor. The first test unit is for inserting a marker frame into the data network via a first point selected from the plurality of end and intermediate points. The marker frame comprises address of the first test unit and a predetermined marker sequence code. Optionally, the marker frame further comprises
an optional marker indicator field being easily detectable by a detection process, to permit ignoring any detected marker frame and thereby avoid interference with the payload traffic
a marker control field to enable a checking for, and discarding of any false positive detections; and
marker time stamp indicating the time of initiating the marker frame.

The traffic monitor is for probing data traffic passing via a corresponding node from the of the plurality of nodes to detect arrival of the marker frame as recognized by the marker sequence code, and for using the first test unit address to forward to the first test unit a tracing frame comprising the node address where the marker frame is detected and a copy of the detected marker frame. In operation, the first test unit recognizes the tracing frame by the marker sequence code contained therein, and builds a list of every node where the marker frame is detected based on the respective node address obtained from the respective tracing frame.

Conveniently, monitoring system further comprises a management network used for transmitting the tracing frame from the at least one traffic monitor to the first test unit.

Typically, the data network is an Ethernet virtual local area network (VLAN), the marker frame has a format compatible with the Ethernet format, and the address of the first test unit is a MAC address.

Another feature of the present system is to perform a continuity check in having the monitoring system insert into the data network a beacon frame for transmission from the first point to a second point selected from the plurality of end and intermediate points. The beacon frame comprises addresses of the first test unit and a predetermined beacon sequence code, and an optional beacon time stamp to enable measurement of latency time delay by the first test unit. The second point is provided with a test loop for returning a response frame to the first test unit using the first unit address comprised in the beacon frame. The response frame comprises a copy of the beacon frame, and an optional response time stamp to enable the first test unit to measure the time required for the response frame to transit from the second point to the first point. The first test unit is operative to check for receipt of the response frame as recognized by the beacon sequence code, and to declare an error status upon failure to receive the response frame within a predetermined time span from inserting the beacon frame.

An alternative use of the present invention to perform a continuity check is by including in the monitoring system a second test unit associated with the second point, wherein the first test unit is operative to insert into the data network a beacon frame for transmission between the first point and a second point selected from the plurality of end and intermediate points, the beacon frame comprising a sequence number, and wherein the second test unit is operative to detect the beacon frame, and upon failure to receive the reflected beacon frame within a predetermined time span from inserting the beacon frame by the first test unit, declares an error status. Furthermore, a management network is used for transmitting to the second test unit, a notification of inserting the beacon frame by the first test unit.

Three alternative tapping techniques are disclosed for use in alternative embodiments of the present invention to establish communication between each traffic monitor and the corresponding node. A first tapping technique is implemented by adding a probe the data network in order to route the marker frame to the first test unit, wherein the MAC address of the first test unit is used by the data network to correctly route the tracing frame to the first test unit. A second tapping technique is implemented by configuring the data network in a managed Queue-in-Queue operation and adding a test VLAN to be monitored and routed to the first test unit. A third tapping technique is implemented by creating a parallel VLAN network connected to the first test unit and routed in a similar manner to the data network.

In a further aspect, the present invention there provides a method for monitoring a data network serving a plurality of intermediate and termination points interconnected by a plurality of nodes. This method comprising the steps of:
i) selecting a first point from the plurality of intermediate and termination points;
ii) inserting a marker frame into the network for transmission from the first point towards the second point, said marker frame comprising address of the first point and a predetermined marker sequence code;
iii) examining data traffic passing via at least one of the plurality of nodes to detect arrival of the marker frame as recognized by the marker sequence code;
iv) forwarding to the first point, using the first point address, a tracing frame comprising a copy of the detected marker frame and the address of each node where the marker frame is detected; and
v) recognizing the tracing frame by the marker sequence code comprised therein, and building a list of every node where the marker frame is detected based on the respective node address derived from the respective tracing frame.

Optionally, this method further comprises a connectivity check performed by the steps of:
vi) selecting a second point from the plurality of intermediate and termination points;
vii) inserting a beacon frame into the data network for transmission between the first and second points, the beacon frame comprising address of the first and second points and a predetermined beacon sequence code;
viii) checking at the second point for receipt of the beacon frame as recognized by the beacon sequence code.
ix) upon receipt of the beacon frame at the second point, returning a response frame to the first test unit using the first unit address, the response frame comprising a copy of the beacon frame; and
x) checking for receipt of the response frame at the first point as recognized by the beacon sequence code, and declaring an error status upon failure to receive the response frame within a predetermined time span from the step of inserting the beacon frame;

An alternative method for the connectivity check performed by the steps of:
vi) selecting a second point from the plurality of intermediate and termination points;
vii) inserting a beacon frame into the data network for transmission between the first and second points, the beacon frame comprising address of the first and second points and a predetermined beacon sequence code; and
viii) checking for receipt of the beacon frame at the second point, and declaring a continuity error status upon failure to receive the beacon frame at the second point.

The present invention offers several advantages over prior art solutions, including the following:
Using indicators inserted within test frames to be sent via an Ethernet network to trace the path.
Ability to use the same trace-routing and continuity check to trace or supervise different network segments. This is very valuable in situation where routes are not connected end-to-end but are in stand-by mode, ready to be put in service in case of trouble on the primary route.
Using special packets/frame which are valid for the node inside the network, in order to follow the tested circuit but can be voluntary irrelevant/invalid for the end point in order to be discarded or looped at the end of the circuit without interfering with the payload traffic.
Only a negligible traffic load being created by the additional test traffic.
Flexibility in implementing the invention under the form of external test resources, internal module or cards in the node or firmware/software modules in the node.

### BRIEF DESCRIPTION OF THE DRAWINGS

The invention will be described in greater detail with reference to the accompanying drawings which represent exemplary embodiments thereof, in which same reference numerals designate similar parts throughout the figures thereof, wherein:

FIG. 1 is schematic diagram of a conventional Ethernet data network in accordance with prior art;

FIG. 2 illustrates a test system for monitoring a network segment of the Ethernet data network shown in FIG. 1, in accordance with an embodiment of the present invention.

FIG. 3 illustrates the flow of beacon frames during a connectivity check in accordance with the embodiment illustrated in FIG. 2;

FIG. 4 illustrates the flow of marker frames during a route tracing test in accordance with the embodiment illustrated in FIG. 2;

FIG. 5 illustrates a first alternative tapping techniques for use in the embodiment illustrated in FIG. 2;

FIG. 6 illustrates a network configuration for implementing the first alternative tapping techniques illustrated in FIG. 5;

FIG. 7 illustrates another network configuration for implementing a second alternative tapping techniques;

FIG. 8 illustrates yet another network configuration for implementing a third alternative tapping techniques; and

FIG. 9 illustrates the contents of each one of the four test frame categories (beacon, response, marker, and tracing frames), generated in accordance with various embodiments of the present invention.

### DETAILED DESCRIPTION

Reference herein to any embodiment means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

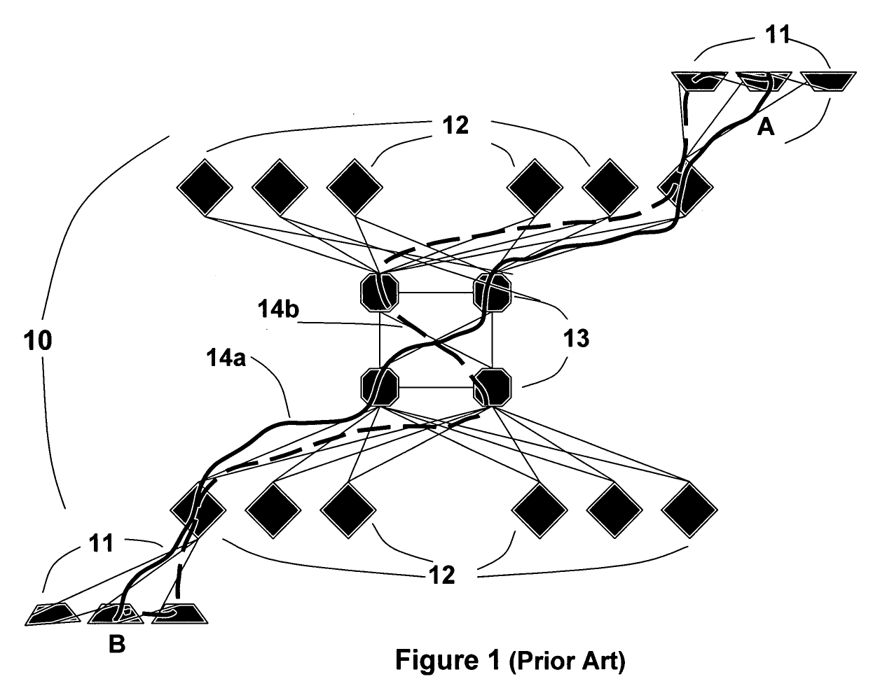

A conventional Ethernet data network 10 illustrated in FIG. 1 typically includes thousands of service ports 11, switchably interconnected via a multiplicity of network nodes including hundreds of metro (intermediate) nodes 12 and tens of core (central) nodes 13. Each port 11 serves one or more end points, whereas each intermediate node 12 serves a cluster of ports 11 via dedicated links, and each intermediate node 12 is linked to more than one of the core node 13, which are interconnected with one another. In this configuration, a connection between a first (originating) end point A, and a second (destination) end point B is established through the port 11 that serves the first end point A, then through at least one of the intermediate nodes 12 and one of the core nodes 13 and again through at least one of the other intermediate nodes 12, and finally through the port 11 that serves the second end point B. As shown in FIG. 1, more than one alternative data routes 14a and 14b are available to connect the first and second end points A and B, depending on the availability of the nodes 12 and 13 and respective links to complete the required path.

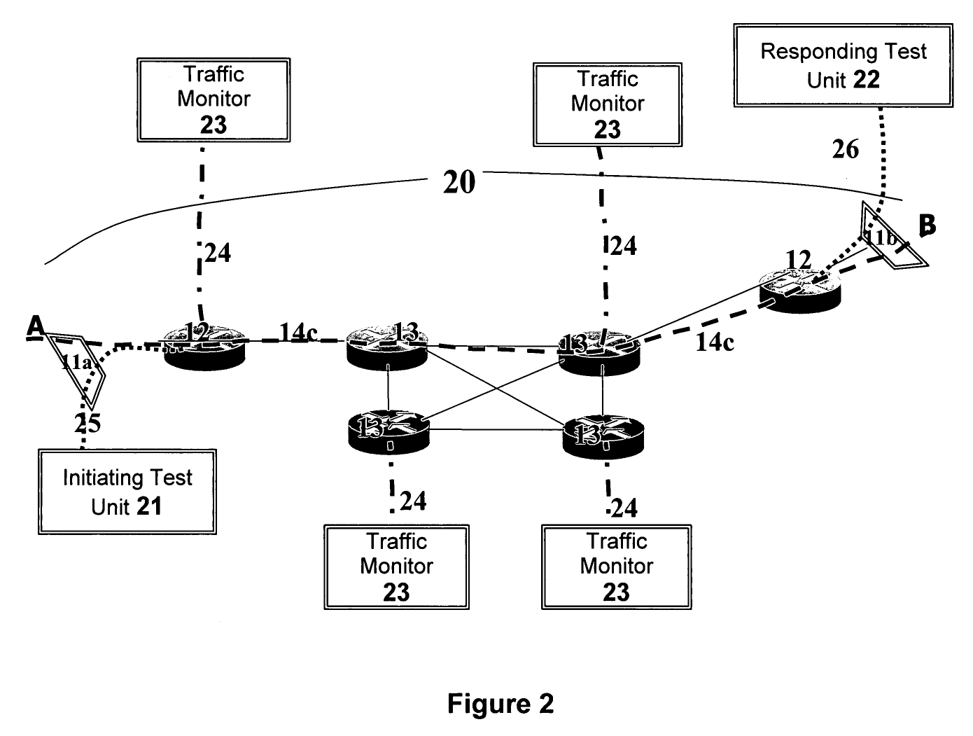

FIG. 2 illustrates a monitoring system in accordance with an embodiment of the present invention for checking connectivity between the first and second end points A and B via a selected one of data routes 14c, and for performing a route tracing test to find a routing error when such connectivity fails to be established between the two points A and B. The monitoring system, according to the present invention, is applied to a network segment 20 of the data network 10 (shown in FIG. 1). The monitoring system includes a first (initiating) test unit 21 in communication with a first port Ha serving the first point A via a first tap 25, at least one traffic monitor 23 in communication with at least one of the nodes 12 via one intermediate tap 24, and a second (responding) test unit 22 in communication with a second port Fib serving the second point B via a second tap 26. Each of the first and second points A and B are selected from any of the end and intermediate points within the network segment 20 to be monitored. Each of the first and second test units 21 and 22 is referenced by a network address.

In this embodiment, the first test unit 21 provides test frames to the first tap 25, for transmission between the first point A and the second point B through the first port 11a, a series of nodes 12 and 13 along the data route 14, and finally the second port 11b. Each traffic monitor 23 then probes data traffic transiting through the respective node to detect arrival of the test frame, by using a respective intermediate tap 24, while leaving the actual data unaffected.

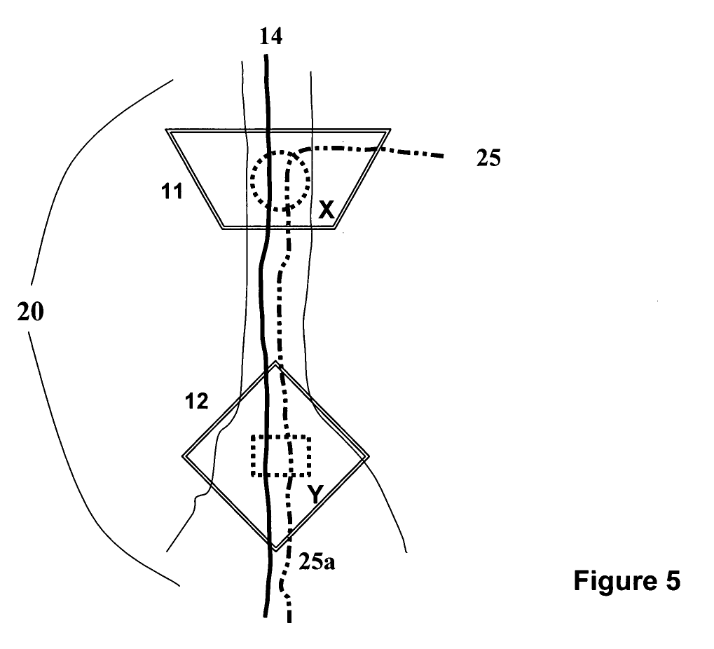

Each of the intermediate, first, and second taps 24, 25 and 26 respectively is provided by a Virtual Local area Network (VLAN) probe using a predefined tapping technique to detect all data traffic passing via any interface of the corresponding network node and extract passing test frames for further reporting. In this embodiment, each VLAN probe contains one network interface and is associated with one network node. The tapping technique is optionally selected from one of the three alternative tapping techniques illustrated in FIGS. 5-8 and described further below.

### Connectivity Check

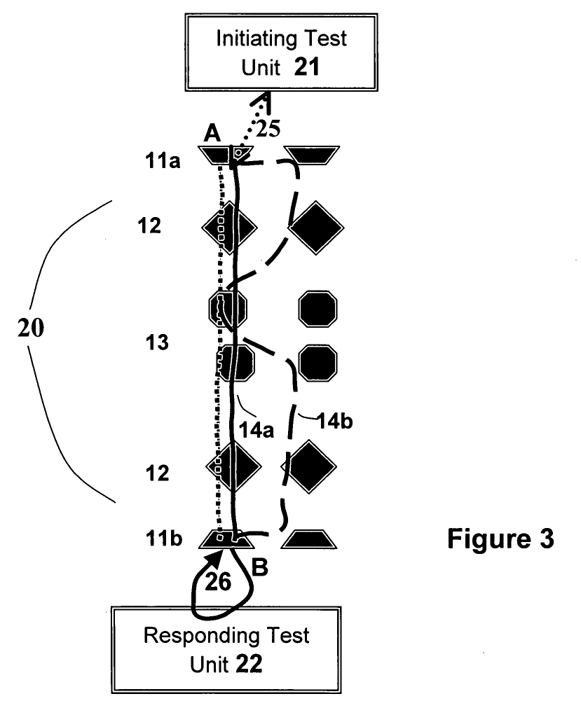

With reference to FIG. 3, the connectivity check is performed by having the first test unit 21 insert into the network segment 20, through the first port Ha serving the originating (first) point A, a test frame in the form of a beacon frame destined for transmission to the second point B. The test frame travels along one of the selected routes, e.g. 14a and 14b, through a series of intermediate and core nodes 12 and 13. The second test unit 22 associated with the destination (second) point B provides a test loop 26 for returning a response frame to the first test unit 21. This way, the first test unit 21 will have the knowledge whether or not the beacon frame has in fact reached the destination point B.

The first test unit 21 periodically monitors the first end point A at predetermined intervals (from a few seconds to a few hours) for receiving a response frame back from the second test unit 22. Once received, the response frame is then extracted from the network using the same tap 25. If no response frame is received within a predetermined time span, a connectivity error status is raised and reported to the Operational Support System (OSS) by the first test unit 21. A route tracing test is then triggered to localise the routing error.

### Route Tracing

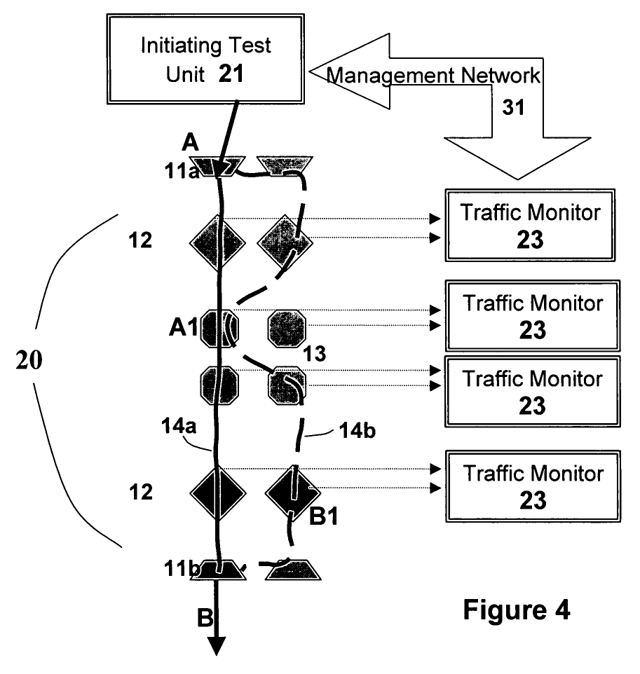

With reference to FIG. 4, the route tracing test is performed by having the first test unit 21 insert into the network segment 20, through the first port 11a serving the first point A, a test frame in the form of a marker frame destined for transmission to the second point B. Any detection of the marker frame at any intermediate node 12 and any core node 13 along the way, by a corresponding traffic monitor 23 is reported to the first test unit 21 for consolidation of the traversed data route illustrated here as being one of alternative data routes 14a and 14b. In the traffic monitor 23, the full content of the marker frame is copied and passed to a reporting module (not shown), which then sends a corresponding tracing frame to the initiating test unit 21 via a management network 31 set up for data collection. The tracing frame includes the copied marker frame plus the network address of the traffic monitor where the marker has been detected. After a predetermined waiting period, after which no more marker frame reports are reasonably expected, the first test unit 21 compiles a log of the route used by the marker frame.

It is to be noted that the above described embodiment is also applicable for performing the continuity check and route tracing test when a first intermediate point A1 is selected as an originating point instead of the first end point A, and similarly when a second intermediate point B1 is selected as a destination point instead of the second end point B, as shown in FIG. 4.

### Tapping Techniques

Disclosed herein are three alternative tapping techniques available for use in the main embodiment of the present invention illustrated in FIG. 2, in cases where the network segment 20 to be monitored is an Ethernet virtual local area network (VLAN). Ethernet equipment is designed to route Ethernet circuits. Ethernet circuits can support multipoint to multipoint operation and so an Ethernet circuit typically has multiple ends. The filtering at an end point is done by a logical address in the form of Media Access Control (MAC) address. Each one of the tapping techniques described below is to provide the first and second taps 24 and 25, as well as the taps 26 within a network segment 20 for the active process of inserting and extracting any one of three categories of test frames, i.e. beacon, response, and marker frames. Active tapping applies to the insertion and extraction of test frames into and out of the network, whereas passive tapping applies to monitoring the passage of test frames as well as making a copy thereof for transmission to the initiating test unit.

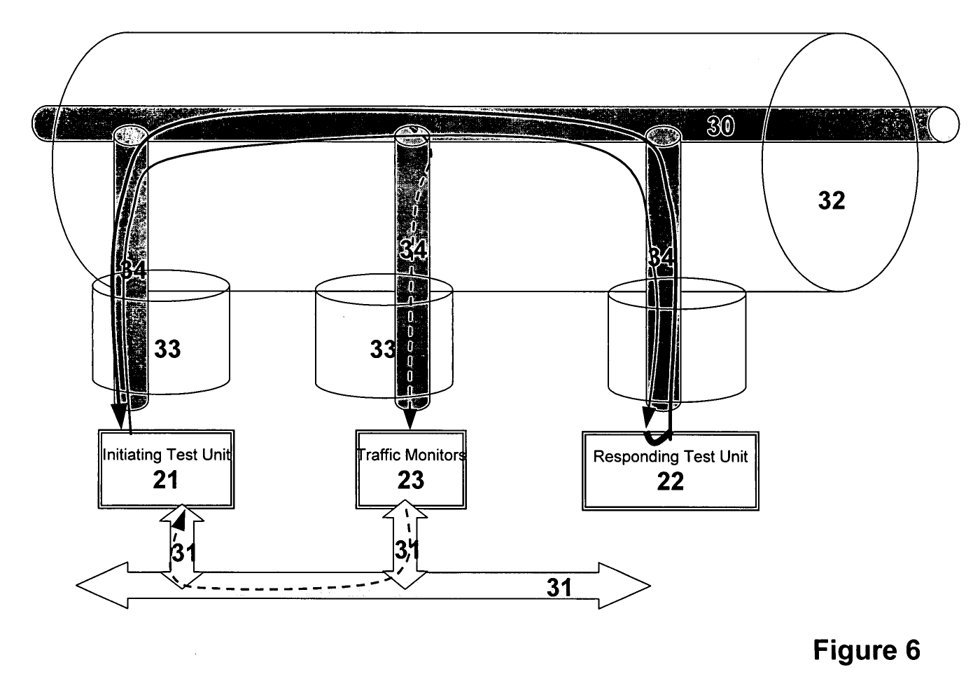

A first tapping technique, as illustrated in FIGS. 5, is implemented in alternative embodiments of the present invention by configuring one of the ports 11 to join the existing VLAN segment 20 to be tapped. In this technique, active tapping is performed to insert test frames into the VLAN by using a provisioned VLAN circuit that merges into an existing circuit X in one of the ports 11. Passive tapping is then performed by tracing the test frames inside the VLAN by configuring each one of the intermediate nodes 12 and core nodes (not shown) to replicate the test frames passing through a selected circuit Y therein and forwarding the replicated test frames towards the corresponding traffic monitor. The network configuration to achieve this process is illustrated in FIGS. 6, wherein the VLAN segment 30 to be tested, which exists within an Ethernet network 32, is configured to route the test frames from and to each of the first (initiating) test unit 21, the second (responding) test unit 22, and any one of the traffic monitors 23 via VLAN taps 34 taken within existing Ethernet taps 33. In this configuration the VLAN segment 30 is used to transport both data traffic and the test frames. The MAC address of the initiating test unit 21 and the responding test unit 22 is used by the Ethernet network 32 to correctly route the test frames.

When performing the connectivity check, in embodiments implementing the first tapping technique, the test frames are exchanged between the initiating test unit 21 and the responding test unit 22 over the VLAN segment 30 through the taps 34. The test frames take the form of beacon frames in the forward direction, and the form of response frame in the reverse direction. When performing, on the other hand, the route tracing test in such embodiments, test frames in the form of marker frame are transmitted from the initiating test unit 21 to the responding test unit 22, through the taps 34 and via a tandem of nodes (not shown), where the passing test frames are detected by corresponding traffic monitors 23. These traffic monitors 23 then route test frames, in the form of tracing frames, to the initiating test unit 21 over the management network 31 set up for data collection.

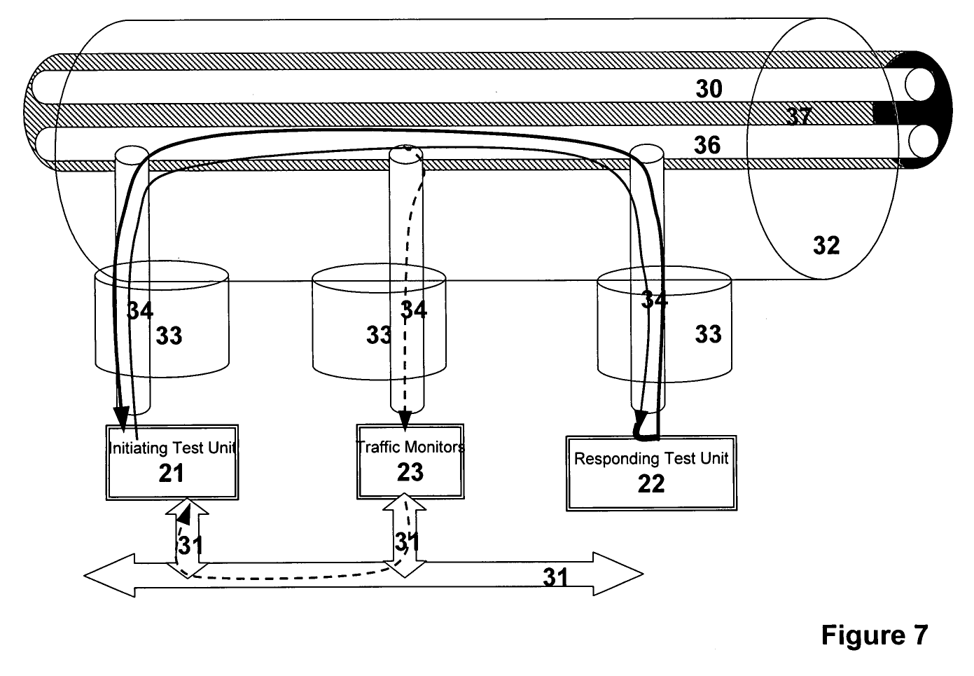

A second tapping technique, as illustrated in FIG. 7, is implemented in embodiments using this technique, by configuring the VLAN segment 30 to be tapped, in a managed Queue-in-Queue operation. With the Queue-in-Queue operation, Ethernet circuits are stacked on top of one another by the addition of an overlay VLAN layer, which in turn can be stacked in another VLAN in a repetitive manner. In this way, a test VLAN 36 is added to the VLAN segment 30. Both the VLAN segment 30 to be tested and the test VLAN 36 are transported within the same parent VLAN 37 within the Ethernet networks 32. This network topology insures that both the VLAN segment 30 and the test VLAN 36 use exactly the same traffic route. The test VLAN 36 is configured to route test frames between the initiating test unit 21, the responding test unit 22, and any one of the traffic monitors 23 via a VLAN tap 34 taken within an existing Ethernet tap 33. In this configuration the VLAN segment 30 is used to transport data traffic, whereas the test VLAN 36 is used to transport the test frames.

When performing the connectivity check, in embodiments implementing the second tapping technique, the test frames (in the form of beacon and response frames) are exchanged between the initiating test unit 21 and the responding test unit 22 over the provisional test VLAN 36 via the taps 34. On the other hand, when performing the route tracing test in such embodiments, test frames in the form of marker frame are transmitted from the initiating test unit 21 to the responding test unit 22, through the taps 34 and via a tandem of nodes (not shown) of the test VLAN 36, wherein the passing test frames are detected by corresponding traffic monitors 23. The traffic monitors 23 then route the test frames in the form of tracing frames to the initiating test unit 21 over the management network 31 set up for data collection.

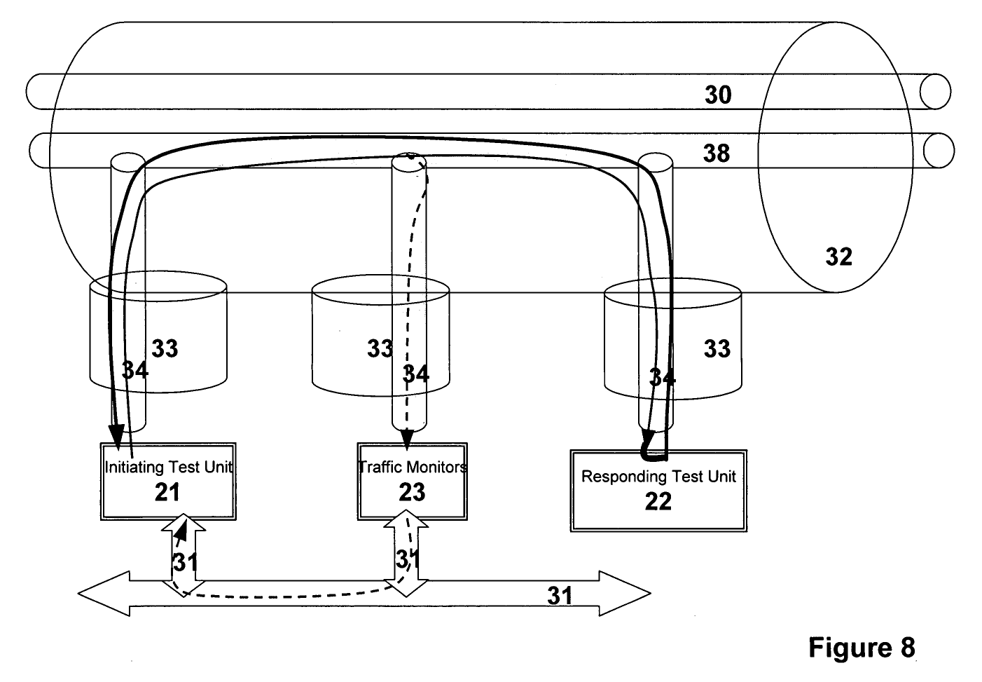

A third tapping technique, as illustrated in FIG. 8, is implemented in embodiments using this technique, by using a dedicated parallel VLAN 38 which is configured to take exactly the same traffic route as the VLAN segment 30 to be tested. Instead of directly tapping into the VLAN segment 30, the test frames are routed in the parallel VLAN 38 along the same path as that followed in the VLAN segment 30. In this way, the parallel VLAN 38 is used to route test frames between the initiating test unit 21, the responding test unit 22 and any one of the traffic monitors 23 via a VLAN tap 34 taken within an existing Ethernet tap 33. In this configuration the VLAN segment 30 is used to transport data traffic whereas the parallel VLAN 38 is used to transport the test frames. In order to allow for monitoring multiple routes from a single interface, several taps are optionally created with the third tapping technique and routed to the port (physical or logical) serving the traffic monitor.

When performing the connectivity check, in embodiments implementing the third tapping technique, the test frames (in the form of beacon and response frames) are exchanged between the initiating test unit 21 and the responding test unit 22 over the provisional parallel VLAN 38 via the taps 34. When performing, on the other hand, the route tracing test in such embodiments, test frames in the form of marker frame are transmitted from the initiating test unit 21 to the responding test unit 22, through the taps 34 and via a tandem of nodes (not shown) of the parallel VLAN 38, wherein the passing test frames are detected by corresponding traffic monitors 23. The traffic monitors 23 then route test frames, in the form of tracing frames, to the initiating test unit 21 over the management network 31 set up for data collection.

Monitoring and testing of a multiple VLAN from a single interface is implemented in alternative embodiments by creating a multiple tap using any one of the first, second and third tapping technique on a single physical interface.

### Test Frame Structures

There are three alternative formats for the four test frame categories (beacon, response, marker and tracing frames) in accordance with various embodiments of the present invention, as follows.
A) In one embodiment, the test frame structure respects the Ethernet format, which allows the test frame to be any one of point-to-point, multicast and broadcast frames. The test frame is embedded within the payload section of a standard Ethernet network to be sent as a simple Ethernet frame. Addressing of test frames exchanged between the initiating entity and responding entities is achieved by the use of the regular Ethernet addressing technique, i.e. MAC Address. This eliminates the need for adding extra Ethernet source and destination addressing fields in the test frame format.
B) In an alternative embodiment, the test frame is embedded within the payload section of a VLAN (802.1q) frame to be sent as a VLAN frame.
C) In an embodiment implementing the second tapping technique mentioned above, the test frame is sent in a “queued in queue” frame, i.e. VLAN in a VLAN configuration.

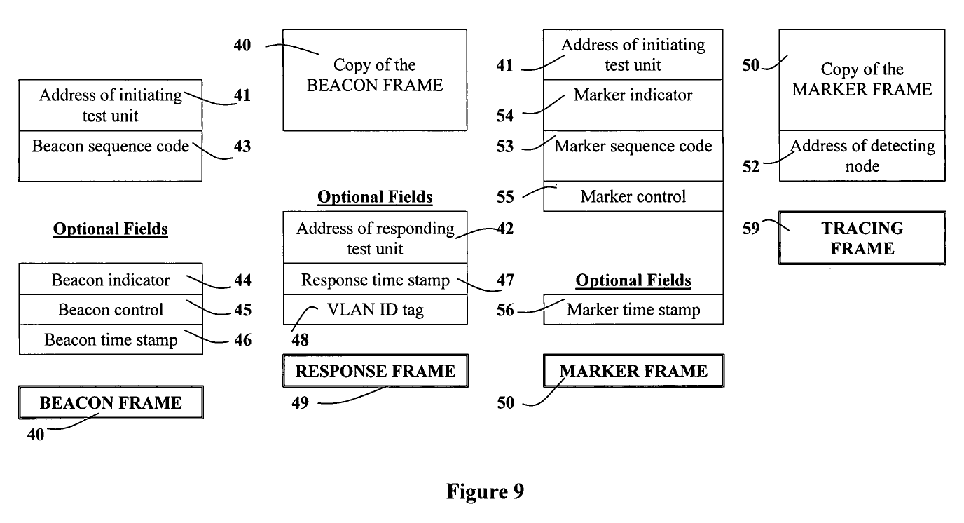

Illustrated in FIG. 9 are the contents of each one of the four test frame categories, as described below. Such contents are optionally coded in accordance with any one of the above three formats.

A beacon frame 40 includes a predetermined beacon sequence code 43 plus originating IP address 41 of the management network interface of the initiating test unit 21 (shown in FIG. 2) to permit return of response frames via the management network 31 (shown in FIG. 4). Optionally the beacon frame 40 further includes any one of other fields such as a beacon indicator field 44, a beacon control field 45, and a beacon time stamp 46 indicating the time of initiating the beacon frame, to enable the first test unit 21 (shown in FIG. 2) to measure latency time delay between inserting the beacon frame into the data network and receiving back the corresponding response frame.

In return, a response frame 49 includes, as shown in FIG. 9, a copy of the received beacon frame 40. In addition, the response frame 49 optionally includes any one of:
a response time stamp 47 indicating the time of generating the response frame 49, to enable the first test unit to measure the time required for the response frame 49 to transit from the second point to the first point;
an identification (ID) tag 48 of the VLAN in which the beacon frame was received, such ID tag to be repeated when a queue in queue mode to allow one VLAN to be coded within another VLAN; and
a destination IP address 42 of the management network interface of the responding test unit 22 (shown in FIG. 2).

A marker frame 50, as shown in FIG. 9, includes the address of the initiating test unit 41, a marker control field 55, and a marker sequence code 53. Optionally the marker frame 50 further includes any one of additional fields such as a marker time stamp 56 to indicate the time of initiating the marker frame 50, in order to enable measurement of latency time delay, by the imitating test unit.

In return, a tracing frame 59 includes, as shown in FIG. 9, a copy of the detected marker frame 50 and the node address 52 where the marker frame 50 has been detected.

Examples of the addresses 41, 42 and 52 include IP address, MAC address, and any other location reference.

The beacon and marker sequence codes 43 and 53, respectively, identify the beacon frame 40 and marker frame 50 to the first and second test units 21 and 22 and any of the traffic monitors 23 (shown in FIG. 2), in order to enable an easy detection of the loss of either of these two frames. One way to generate these sequence codes is by following a predetermined alphanumeric order. Another way is random coding.

The beacon and marker indicator fields 44 and 54 are specifically coded to be easily detectable by a simple, but relatively fast, detection process located at any one of the initiating and responding test units 21 and 22 and the traffic monitors 23 (shown in FIG. 2) within the network typically required for a large flow of data. Upon detection of any one of the beacon indicator field 44 and marker indicator field 54, the detection process acts to ignore the originating address 41 and the destination address 42 and any other Ethernet fields to avoid their interfering with the payload traffic, thereby minimizing the additional data traffic resulting from inserting the test frames in order to save processing time. Otherwise, if any of the beacon indicator field 44 and marker indicator field 54 is absent, every beacon and marker frame detected by the detection process will trigger a response.

The beacon control field 45 and the marker control field 55 enable checking for, and discarding of, false positive detections likely to be created by the fast detection process. Optionally any one of these two fields further includes extra control bytes on the source and destination MAC addresses and other Ethernet fields, to enable completion of the false positive detections.

In particular implementations, the test frame fields described above are coded as follows:
The IP addresses of the initiating and responding units 41 and 42 respectively are passed in ASCII format. Differentiation between IPV4 and IPV6 addresses is done by the text representation.
Each of the beacon sequence code 43 and marker sequence code 53 is formatted in text as a 4 digits number, where 0000 indicates a cold start. After a 9999 sequence code is reached, the system restarts at 0001.
Each of the beacon marker indicator field 44 and marker indicator field 54 is coded in binary in the form of the 64 bits hexadecimal representation of “7F AA 7F 55 FF 55 00 AA”.
Each of the beacon control field 45 and marker control field 55 is coded as the MD5 checksum of the overall Ethernet payload and is coded in 128 bits.
Each of the beacon, response, and marker time stamps 46, 47 and 56, respectively, is passed in text as AAAAMMJJ-HH:MM:SS:[mmm]
The VLAN ID tag 48 is coded in text as a 5 digit number.

The first test unit recognizes the tracing frame by the marker sequence code contained therein, and builds a sequential list of every node where the marker frame is detected based on the respective node address obtained from the respective tracing frame.

### Alternative Embodiments

The above-described embodiments are intended to be examples of the present invention. Numerous variations, modifications, and adaptations, such as those mentioned below, may be made to the particular embodiments by those of skill in the art, without departing from the spirit and scope of the invention, which are defined solely by the claims appended hereto.

Some probes may have more than one network interfaces and are therefore capable of tapping into more than one network node, instead of one network interface per probe used in the main embodiment. Possible probe implementations include internal software probes, and internal and external hardware probes.

Instead of using the test loop 26 shown in FIG. 3, the connectivity check is optionally performed by having each of the first and second test units 21 and 22 insert into the network segment 20 a separate beacon frame destined to the other test unit, and accordingly inform the other test unit of such action using the management network 31. Then each test unit periodically monitors the corresponding end point thereof for receiving a beacon frame from the other test unit. In other words, both forward and return directions between the fist and second end points A and B are monitored independently. In this embodiment, the management network 31 (shown in FIG. 4) is used by the two test units as return path to inform each other of the insertion and/or reception of the beacon frame.

The fast detection process mentioned above within the initiating and responding test units 21 and 22 and traffic monitors 23 (all shown in FIG. 2) and the traffic monitors 23 (shown in FIG. 2) is implemented either in hardware or in software. Alternative hardware implementations include field programmable gate arrays (FPGA), application-specific integrated circuits (ASIC), and Digital Signal Processor (DSP). The traffic monitors 23 may be implemented as external test resources, internal modules or cards, or firmware/software modules, in any of the nodes 12 and 13.

Some networks, in their core part, derive from standardized Ethernet frames to add some proprietary facilities. In such case the frame may deviate from Ethernet frame format, by using special non-standardized frames.

As an alternative to the coding scheme given above for the main embodiment, the fields within the test frames may be coded in XML.

We claim:

1. A monitoring system for a data network serving a plurality of end and intermediate points interconnected by a plurality of nodes, the system comprising:
a) a first test unit for inserting a marker frame, comprising an address of the first test unit and a marker sequence code, into the data network via a first point selected from the plurality of end and intermediate points,;
b) at least one traffic monitor, each traffic monitor connected to one of the plurality of nodes for probing data traffic passing therethrough to detect arrival of the marker frame as recognized by the marker sequence code; and for forwarding a tracing frame comprising the node address where the marker frame is detected and a copy of the detected marker frame, to the first test unit using the first test unit address,
wherein, in operation, the first test unit recognizes the tracing frame by the marker sequence code contained therein, and builds a list of every node in which the marker frame is detected based on each node address obtained from each tracing frame.

2. The monitoring system of claim 1, further comprising a management network for transmitting the tracing frame from the at least one traffic monitor to the first test unit.

3. The monitoring system of claim 1, wherein the data network is an Ethernet virtual local area network (VLAN), wherein the marker frame has a format compatible with the Ethernet format, and wherein the address of the first test unit is a MAC address.

4. The monitoring system of claim 1,
wherein the first test unit is operative to insert into the data network a beacon frame for transmission from the first point to a second point, selected from the plurality of end and intermediate points, the beacon frame comprising the address of the first test unit and a predetermined beacon sequence code;
wherein the second point is provided with a test loop for returning a response frame to the first test unit using the first unit address comprised in the beacon frame, the response frame comprising a copy of the beacon frame; and
wherein the first test unit is operative to check for receipt of the response frame as recognized by the beacon sequence code, and to declare an error status upon failure to receive the response frame within a predetermined time span from inserting the beacon frame.

5. The monitoring system of claim 4, wherein the beacon frame further comprises a beacon time stamp to enable measurement of latency time delay by the first test unit.

6. The monitoring system of claim 4, wherein the response frame further comprises a response time stamp to enable the first test unit to measure the time required for the response frame to transit from the second point to the first point.

7. The monitoring system of claim 1, further comprising a second test unit associated with the second point,
wherein the first test unit is operative to insert into the data network a beacon frame for transmission between the first point and a second point selected from the plurality of end and intermediate points, the beacon frame comprising a sequence number, and
wherein the second test unit is operative to detect the beacon frame, and to declare an error status upon failure to receive the beacon frame from the first test unit within a predetermined time span.

8. The monitoring system of claim 7, further comprising a management network used for transmitting a notification to the second test unit that the first test unit inserted the beacon frame.

9. The monitoring system of claim 3, further comprising a VLAN probe between each traffic monitor and the corresponding node, for routing the marker frame and the tracing frame between the each traffic monitor and the first test unit, wherein the MAC address of the first test unit is used by the data network to correctly route the tracing frame to the first test unit.

10. The monitoring system of claim 3, further comprising a test VLAN being monitored and routed to the first test unit, for routing the marker frame and the tracing frame between the each traffic monitor and the first test unit, wherein the test VLAN is added by configuring the data network in a managed Queue-in-Queue operation.

11. The monitoring system of claim 3, further comprising a parallel VLAN connected to the first test unit and routed in a similar manner to the data network, for routing the marker frame and the tracing frame between each traffic monitor and the first test unit.

12. The monitoring system of claim 1, wherein the marker frame further comprises a marker indicator field being easily detectable by a detection process, to permit ignoring any detected marker frame and thereby avoid interference with the payload traffic.

13. The monitoring system of claim 12, wherein the marker frame further comprises a marker control field to enable a checking for, and discarding of any false positive detections.

14. The monitoring system of claim 1, wherein the marker frame further comprises a marker time stamp indicating the time of initiating the marker frame.

15. A method for monitoring a data network serving a plurality of intermediate and termination points interconnected by a plurality of nodes, the method comprising the steps of:
i) selecting a first point from the plurality of intermediate and termination points;
ii) inserting a marker frame into the network for transmission from the first point towards the second point, said marker frame comprising an address of the first point and a predetermined marker sequence code;
iii) examining data traffic passing via at least one of the plurality of nodes to detect arrival of the marker frame as recognized by the marker sequence code;
iv) forwarding to the first point, using the first point address, a tracing frame comprising a copy of the detected marker frame and the address of each node where the marker frame is detected; and
v) recognizing the tracing frame by the marker sequence code comprised therein, and building a list of every node where the marker frame is detected based on the respective node address derived from the respective tracing frame.

16. The method of claim 15, wherein the data network is an Ethernet virtual local area network (VLAN), the marker frame has a format compatible with the Ethernet format, and the address of the first test unit is a MAC address.

17. The method of claim 15 further comprising a connectivity check performed by the steps of:
vi) selecting a second point from the plurality of intermediate and termination points;
vii) inserting a beacon frame into the data network for transmission between the first and second points, the beacon frame comprising address of the first and second points and a predetermined beacon sequence code;
viii) Checking at the second point for receipt of the beacon frame as recognized by the beacon sequence code.
ix) upon receipt of the beacon frame at the second point, returning a response frame to the first test unit using the first unit address, the response frame comprising a copy of the beacon frame; and
x) checking for receipt of the response frame at the first point as recognized by the beacon sequence code, and declaring an error status upon failure to receive the response frame within a predetermined time span.

18. The method of claim 17, wherein the beacon frame further comprises a beacon time stamp to enable measurement of latency time delay by the first test unit.

19. The method of claim 15, further comprising a connectivity check performed by the steps of:
vi) selecting a second point from the plurality of intermediate and termination points;
vii) inserting a beacon frame into the data network for transmission between the first and second points, the beacon frame comprising addresses of the first and second points and a predetermined beacon sequence code; and
viii) checking for receipt of the beacon frame at the second point, and declaring a continuity error status upon failure to receive the beacon frame at the second point.
